(19) United States
(12) Patent Application Publication
(10) Pub. No.: US 2024/0402952 A1
(43) Pub. Date: Dec. 5, 2024

(54) PRINT CONTROL APPARATUS, METHOD FOR CONTROLLING PRINT CONTROL APPARATUS, AND STORAGE MEDIUM

(71) Applicant: CANON KABUSHIKI KAISHA, Tokyo (JP)

(72) Inventor: Tetsuya Hamada, Kanagawa (JP)

(21) Appl. No.: 18/669,777

(22) Filed: May 21, 2024

(30) Foreign Application Priority Data
May 31, 2023 (JP) 2023-089412

(51) Int. Cl. G06F 3/12; G06F 3/0482

(52) U.S. Cl. CPC G06F 3/1208; G06F 3/0482; G06F 3/1204; G06F 3/1256; G06F 3/1257

(57) ABSTRACT

A print control apparatus includes: an acceptance unit that accepts an editing operation of a parameter set associated with a print medium by a user on an editing screen for editing the parameter set; and a notification unit that notifies the user in a case where editing a specific parameter among a plurality of parameters included in the parameter set leads to the need for changing other settings related to the specific parameter that are not included in the parameter set.

### BACKGROUND

### Field

The present disclosure relates to a print control apparatus, a method for controlling the print control apparatus, and a program.

### Description of the Related Art

There is a multilayer print medium called a sticker or label that is made up of a sheet attached to backing paper. Depending on its intended use, such a print medium is made of a material in an eye-catching color or a weather-resistant material. There are many colors or types of print media, such as materials colored in gold, silver or other colors, paper, or film materials. For optimal printing using such print media with various characteristics, many printing parameters can be set in a printer. Combining a plurality of printing parameters enables printing under optimal conditions for a print medium. Examples of parameters required for printing include printing speed, amount of color ink applied, drying temperature after color printing, presence or absence of white printing for printing designs or characters with white ink, amount of white ink applied, drying temperature after white printing, settings of color profile to use, and the like. White ink is used as a base for color printing and has the effect of preventing color printing from showing through. A user sets these printing parameters in association with the print medium to perform printing.

Japanese Patent Application No. 2017-529024 describes a technique that requires the user, in a case where some setting items are missing for a print job, to input such missing parameters through a user interface.

### SUMMARY

The printing parameters for the print medium that the user uses can be optimized by reusing printing parameters of a print medium with similar characteristics to the print medium that the user uses for printing, from among the print media already associated with printing parameters, and by changing necessary parts. Some printing parameters, if changed, may require readjustment of the printer, such as redoing color calibration, recreating a color profile, or resetting a density correction table. Some users may find it difficult to understand the relationship between changes in printing parameters and print results, and to change the printing parameters and readjust the printer without error.

A print control apparatus according to an aspect of the present disclosure includes: an acceptance unit that accepts an editing operation on a parameter set associated with a print medium by a user on an editing screen for editing the parameter set; and a notification unit that notifies the user in a case where other settings are required that are not included in the parameter set related to a specific parameter, among a plurality of parameters included in the parameter set, as the specific parameter is edited.

Further features of the present invention will become apparent from the following description of exemplary embodiments with reference to the attached drawings.

### BRIEF DESCRIPTION OF THE DRAWINGS

FIG. 1 is a configuration diagram of an image forming apparatus;

FIG. 2 is a functional block diagram of the image forming apparatus;

FIG. 3 is a basic flowchart of printing;

FIG. 4 is an example of a print job list screen;

FIG. 5 is an example of a printing parameter editing screen;

FIGS. 6A and 6B are examples of a pull-down screen;

FIG. 7 is an example of a pop-up screen;

FIG. 8 is an example of a pop-up screen;

FIG. 9 is an example of an adjustment function selection UI screen;

FIG. 10 is a flowchart of pop-up screen display control; and

FIG. 11 is a flowchart of color profile creation.

### DESCRIPTION OF THE EMBODIMENTS

Hereinafter, preferred embodiments of the present disclosure will be described in detail with reference to the accompanying drawings. Note that the following embodiments do not limit the present disclosure according to the claims, and all combinations of features described in the embodiments are not necessarily essential to the solution of the present disclosure.

### First Embodiment

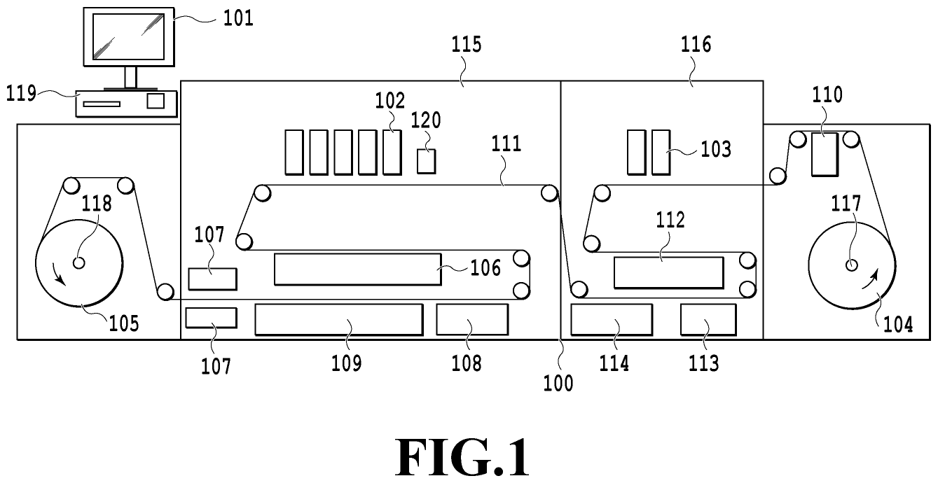

A configuration of an image forming apparatus according to the present embodiment will be described. FIG. 1 is an example of a schematic configuration of an image forming apparatus 100 according to the present embodiment. The image forming apparatus 100 is an apparatus that forms images on a continuous print medium (hereinafter referred to as roll paper) 111 that is capable of forming continuous images and is used in the present embodiment. In the present embodiment, the image forming apparatus 100 includes a feeding device 104 that feeds the roll paper 111, and a printing unit 116 that performs particular color printing. The image forming apparatus 100 further includes a printing unit 115 that performs basic color printing, a winding device 105 that winds the roll paper 111, and a user interface (hereinafter referred to as UI) operation panel 101. The feeding device 104 is a device that supplies the roll paper 111 to the image forming apparatus 100. The feeding device 104 rotates a paper tube of the roll paper 111 around a rotation shaft 117 to convey the roll paper 111 wound around the paper tube toward the image forming apparatus 100 at a constant speed via a plurality of rollers (a conveyance roller, a feeding roller, and the like). The winding device 105 is a device that winds the roll paper 111 conveyed from the image forming apparatus 100 into a roll shape around a paper tube. The paper tube is attached to a rotation shaft 118 and is rotated around the rotation shaft 118 to wind the roll paper 111 conveyed to the paper tube via a plurality of rollers (for example, a conveyance roller and a discharge roller) as a printed product at a predetermined speed. The printed product is wound around a paper tube and held in a roll. As a work before starting printing, the roll paper 111 is passed from the feeding device 104 to the winding device 105. The roll paper 111 is set in the feeding device 104, and the leading edge of the roll paper 111 is passed over a skew correction device 110. Next, the roll paper 111 is passed under a printing apparatus 103 of the printing unit 116. The printing apparatus 103 in the present embodiment uses a color such as white ink, for example, other than color inks, that is, cyan (C), magenta (M), yellow (Y), and black (K) (CMYK) for printing. The roll paper 111 is then passed under a drying device 112 and above cooling devices 113 and 114. Thereafter, in the printing unit 115, the roll paper 111 is passed under a mark detecting sensor 120 and a printing apparatus 102, and then passed below a drying device 106 and above cooling devices 108 and 109. In the present embodiment, the mark detecting sensor 120 is used for alignment in a case where the printing apparatus 102 forms an image on an image formed by the printing apparatus 103. However, the present disclosure is not limited thereto and a scanner device may be used. The printing apparatus 102 of the present embodiment uses basic printing colors (CMYK) for printing. The roll paper 111 is then passed through a connected scanner device 107 and wound onto the winding device 105. After the roll paper 111 is passed through the image forming apparatus 100, a print job is inputted to a control PC (print control apparatus) 119 for the image forming apparatus 100. After the print job is inputted, a print start button on the UI operation panel 101 is pressed to start printing. The printed image is read by the scanner device 107 and the read image is analyzed by the control PC 119 to check if the printed product has any defect. The control PC can also edit the inputted print job.

Next, a control configuration of the image forming apparatus 100 will be described in detail.

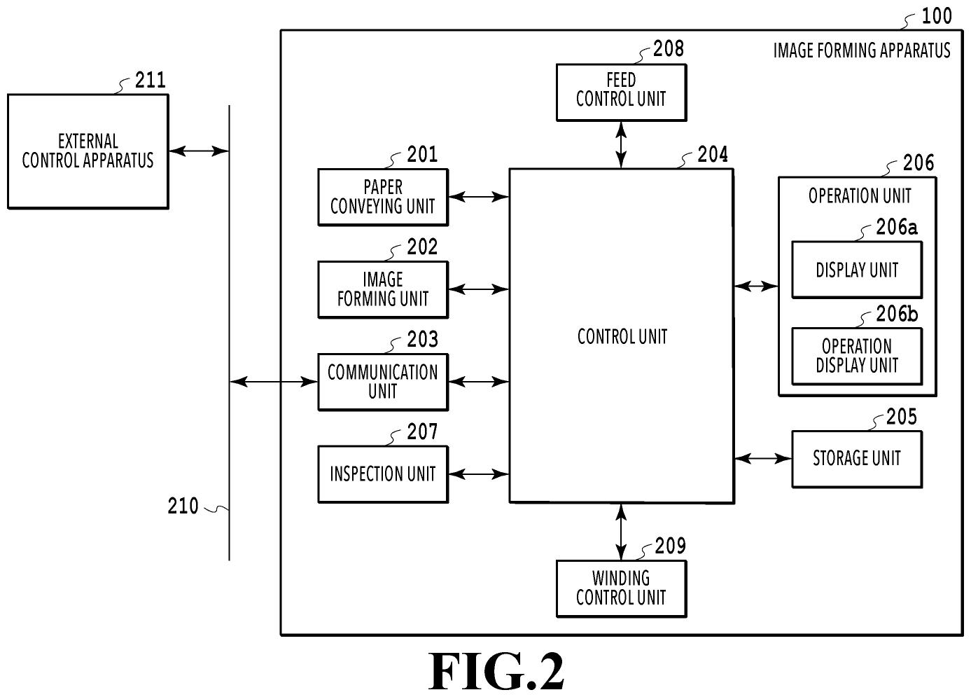

FIG. 2 is a functional block diagram showing the control configuration of the image forming apparatus 100. As shown in FIG. 2, the image forming apparatus 100 includes a paper conveying unit 201, an image forming unit 202, a communication unit 203, a control unit 204, a storage unit 205, an operation display unit 206, an inspection unit 207, a feed control unit 208, and a winding control unit 209. The paper conveying unit 201 is a conveying mechanism for the roll paper 111 inside the image forming apparatus 100. For example, the roll paper 111 conveyed from the feed control unit 208 is conveyed to the image forming unit 202 by a plurality of rollers, and the roll paper 111 passed through the image forming unit 202 is conveyed to the winding control unit 209. The image forming unit 202 forms an image on the roll paper 111 supplied from the feed control unit 208, based on print data for which an output instruction is received. The image forming unit 202 conveys the roll paper 111 with the image formed thereon toward the winding control unit 209. The communication unit 203 is configured using a communication control card such as a local area network (LAN) card, for example. Various data are transmitted and received between the image forming apparatus 100 and an external control apparatus 211 (for example, a personal computer) connected to a communication network 210 such as a LAN or a wide area network (WAN). The external control apparatus 211 has installed therein printing applications required for printing.

The control unit 204 includes a central processing unit (CPU), a random access memory (RAM), and the like, for example. The CPU of the control unit 204 reads various programs such as a system program or a processing program stored in the storage unit 205, expands the program into the RAM, and executes various processing according to the expanded program. For example, the control unit 204 can perform image forming processing to execute an image forming job (hereinafter referred to as a job) according to an instruction of a user. The storage unit 205 is configured using a non-volatile semiconductor memory (so-called flash memory), a hard disk drive (HDD) or the like, for example. The storage unit 205 stores various programs including the system program and processing program executed by the control unit 204, as well as various data required to execute these programs. The operation display unit 206 is configured using a liquid crystal display (LCD) with a touch panel, for example, and includes a display unit 206a and an operation unit 206b. The display unit 206a displays various information on a display screen according to a display control signal inputted from the control unit 204. The operation unit 206b includes various operation keys such as a numeric keypad and a start key, receives various input operations from the user, and outputs operation signals to the control unit 204. The operation display unit 206 is used, for example, to set job information in a case of executing a job. The user can arbitrarily set any conditions such as paper to be used, information on printing speed, number of sheets to be printed, number of copies to be printed, printing length, and printing diameter.

Next, a description will be given of an operation in a case where the image forming apparatus 100 performs image forming processing on the roll paper 111. First, the user creates print job data in an external apparatus, performs print setting and delivery roll number setting for the job, and transmits this information to the image forming apparatus 100 through the communication network. The control unit 204 of the image forming apparatus 100 receives, via the communication unit 203, a job ticket including the job data, job print setting information, delivery roll number information, and the like transmitted from the external apparatus. The inspection unit 207 is a device that checks if printing is successfully performed on the print image sheet without ejection failure. A detection pattern for ejection failure inspection is printed and read by a scanner to check if there is an ejection failure in the printed image. The image forming apparatus is stopped if an ejection failure is detected. There are various inspection methods, such as printing a detection pattern and reading it with a scanner, directly reading the printed image with a camera or scanner, and monitoring an ejection status from a nozzle. In the present embodiment, a detection pattern is printed and read with a scanner to check if there is an ejection failure.

Next, a basic flowchart of printing with the image forming apparatus 100 will be described step by step.

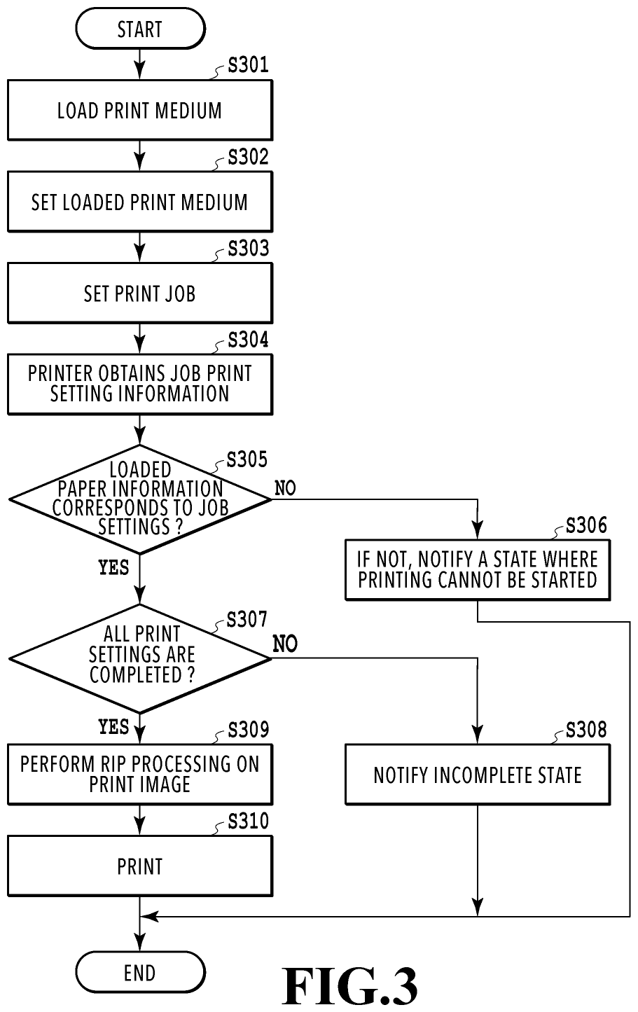

FIG. 3 is a basic printing flowchart illustrating a flow from loading a print medium on the image forming apparatus 100 to printing. In the processing of this flowchart, the CPU of the control unit 204 reads various programs such as the system program or processing program stored in the storage unit 205, expands the programs into the RAM, and executes various processing according to the expanded programs. Note that the symbol “S” in the description of each process of this flowchart means a step in the flowchart. The same applies to subsequent flowcharts.

First, in S301, a print medium is loaded into the feeding device 104 of the image forming apparatus 100. In the present embodiment, the print medium is wound into a roll. The rolled print medium is pulled out and passes through a plurality of conveyance rollers along the path of the conveyance mechanism of the printer, and is fixed to a winding core attached to the winding device 105 at the end of the conveyance path. In step S302, the user sets the print medium loaded in the printer before starting print processing. This setting is performed by specifying one of the print media pre-registered with the printer. This allows optimal conveyance parameters linked to be set, which are associated with prestored print medium information, making it possible to appropriately convey the loaded print medium.

The parameters set for a print job include, besides the conveyance parameters, presence or absence of white printing, a contrast ratio in white printing, drying temperature after white printing or drying temperature in color printing, and tension applied to the print medium. The type of ink used, the type of color profile used in color matching, and the like are also conceivable. Note that these printing parameters are merely examples, and the present embodiment is not limited thereto. If the list does not include the same print medium as that loaded in the printer, a print medium with similar physical properties or features to those of the loaded print medium is selected. The physical properties include the type of material of the print medium (such as coated paper, high-quality paper, or film), thickness, width, or basis weight of the print medium.

In S303, the user sets a print job in which data to be printed, a medium to be printed, or print settings are described. Note that the processing of S302 and S303 is executed by the user operating the control PC (print control apparatus) 119 for the image forming apparatus 100. The created print job is sent to the image forming apparatus 100. In S304, the control unit 204 of the image forming apparatus 100 obtains print setting information including the print job set by the user of the image forming apparatus 100. The print job included in the print setting information is then analyzed.

In S305, before starting printing, the image forming apparatus 100 determines whether the print medium specified in the print job corresponds to the print medium loaded in the printer. If the print medium specified in the print job does not correspond to the print medium loaded in the printer, the control unit 204 proceeds to S306 to notify the user that printing cannot be started. If the print medium specified in the print job corresponds to the print medium loaded in the printer, the control unit 204 proceeds to S307 to determine whether all print settings required for printing are completed. If it is determined in S307 that the print settings required for printing are incomplete, the control unit 204 proceeds to S308 to notify the user of the incomplete state. If it is determined that all the print settings required for printing are set, the control unit 204 proceeds to S309 to perform raster image processor (RIP) processing on the print image data specified in the print job.

The RIP processing can convert vector image data, which is image data described by commands, into raster image data, which is a collection of printing pixels. In addition, some printers have a color conversion function that converts the colors of print data. In S310, the control unit 204 executes printing of the print image data generated by the RIP. The control unit 204 then ends the processing of this flowchart.

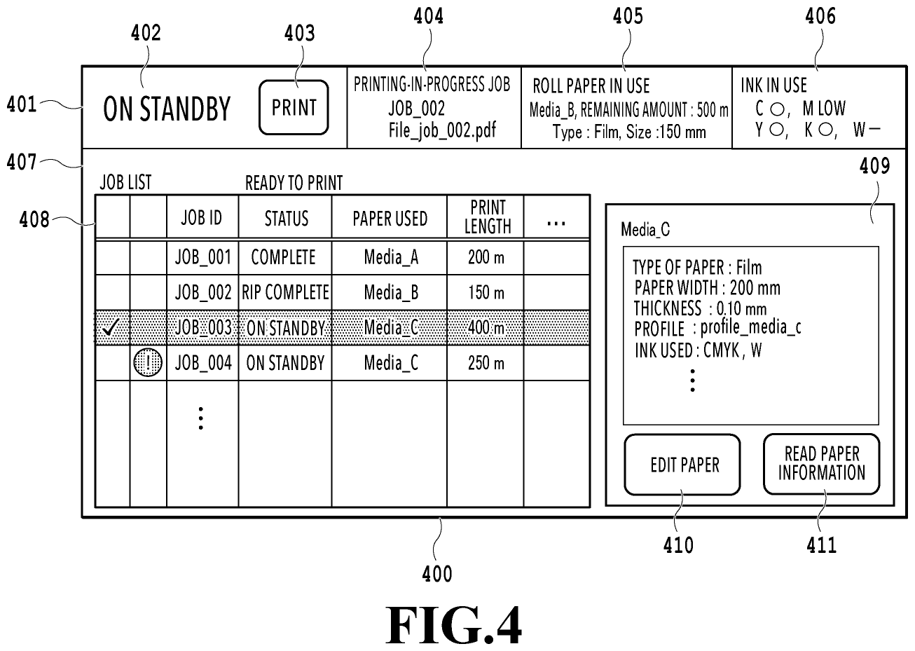

FIG. 4 is an example of a UI screen that displays a list of print jobs. In FIG. 4, the entire UI screen 400 is the entire UI displayed on the UI operation panel 101. A status display area 401 displays summary information on the state of the image forming apparatus 100, such as the current state of the image forming apparatus 100 or information on the printing job in progress. An operation status display 402 of the image forming apparatus 100 shows the status of the image forming apparatus 100, which is “on standby” for printing in FIG. 4. Besides “on standby”, the operation status includes states such as “suspended” and “printing”. Printing of the selected print job is started by pressing a “Print” button 403. A printing-in-progress job display 404 shows the name of the job to be printed. A print medium information display 405 shows the name and remaining amount of the print medium loaded in the image forming apparatus 100. An ink status display 406 shows the type of ink used or the ink level.

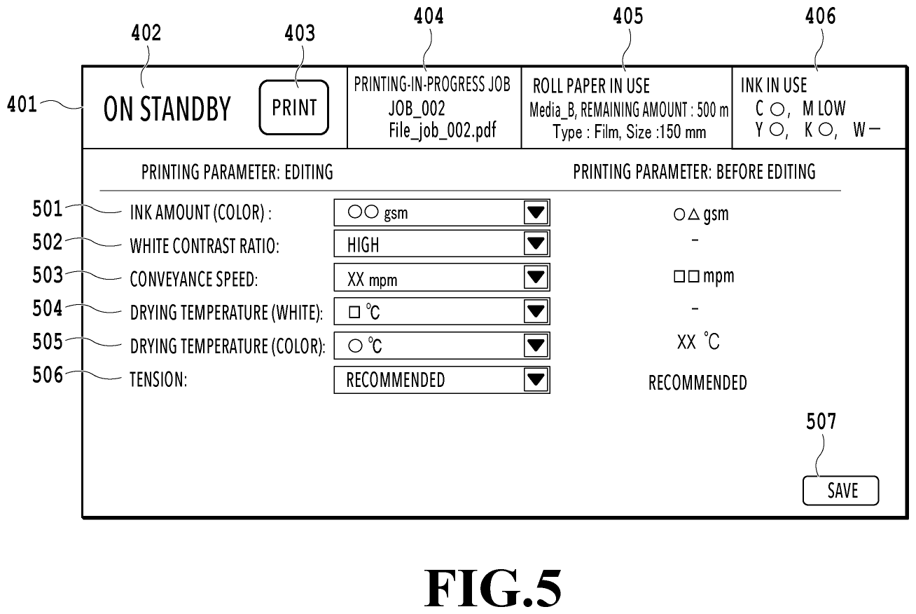

In the present embodiment, the operation status display of the image forming apparatus 100, the print button, the printing-in-progress job display, the print medium information display, and the ink status display have been described as an example of the content of the status display area 401. However, the present disclosure is not limited thereto and states other than those described above may be displayed. A work area 407 is for the user to perform operations. In a case of checking detailed information on each piece of information in the status display area 401, relevant detailed information can be displayed in the work area 407 by pressing each status display region of the status display area 401. For example, pressing the printing-in-progress job display 404 switches to the print job list display in FIG. 4. A method for switching the screen is not limited thereto, but a menu screen may be provided to switch the screen by selecting a menu. The print job list 408 shows information such as a print job ID, current status, or print medium. The image forming apparatus 100 starts printing as the print button 403 is pressed for the job selected in this list. The print medium information display 409 shows detailed information on the print medium. An “Edit paper” button 410 allows editing of the print medium information displayed in the print medium information display 409. FIG. 5 shows a print medium editing screen. A “Read paper information” button 411 is used to read new paper information, which is not the currently set paper information. The settings read using the “Read paper information” button 411 are displayed on the print medium information display 405 as information on the print medium loaded in the image forming apparatus 100.

FIG. 5 shows a UI screen for editing the printing parameters. If no information on a printing substrate is registered in the image forming apparatus 100, it is necessary to select a registered print medium that has similar physical properties or features to the print medium loaded in the image forming apparatus 100. However, the printing parameters are only optimized for a similar print medium, and are not always suitable for the print medium selected by the user. In such a case, a combination of printing parameters optimized for the print medium selected by the user can be created by changing the printing parameters.

The UI screen for editing the printing parameters shown in FIG. 5 can be displayed as a part of the entire UI screen 400 by pressing the “Edit paper” button 410 in FIG. 4. The parameter set shown in FIG. 5 includes ink amount (color) 501, white contrast ratio 502, drying temperature (white) 504, drying temperature (color) 505, and tension 506. The user can select setting values for each parameter from a pull-down menu for each parameter.

With the ink amount (color) 501, the maximum amount of color ink to be applied in printing can be selected. By increasing the color ink application amount, expansion of a printing color gamut and improvement in maximum color density in printing can be expected, and color reproducibility of printing results can be further improved. However, depending on the print medium, increasing the ink amount may cause problems such as that the ink cannot be fixed or sufficiently dried after printing. Therefore, the ink amount needs to be changed taking into consideration the relationship between the properties of the print medium and the printing conditions (drying temperature or conveyance speed)

With the white contrast ratio 502, the contrast ratio in a case of white printing can be selected. One possible use for printing with white ink is a case where designs or characters are wished to be printed with white ink. There is also a case where a base for color printing is printed with white ink. By printing a base with white ink and then performing color printing thereon, the influence of the background color of the print medium can be eliminated for color printing. In a case of a transparent print medium, background printing can prevent the color-printed part from showing through. No background preparation with white ink hinders print results from having normal tonality under the influence of the background color of the print medium.

With the white contrast ratio 502, the conveyance speed of the print medium can be selected. The image forming apparatus 100 of the present embodiment is configured to print on a roll of print medium and wind the printed product again into a roll after printing. The faster the conveyance speed of the print medium, the more the print amount per unit time can be increased, thus improving the production efficiency. However, fast conveyance may lead to insufficient drying after printing. Therefore, it is preferable that the conveyance speed is determined in consideration of the correlation between the properties of the print medium and the ink application amount or the drying temperature.

With the drying temperature (white) 504, the temperature of the drying mechanism after printing with white ink can be selected. In a case where the conveyance speed of the print medium is high, it is necessary to make adjustments such as setting the drying temperature high, in order to achieve a sufficiently dry state. Depending on the type of glue applied to a print medium such as a film or a print medium for stickers, exposure to high temperatures may cause the print media to shrink or deform, or cause the glue to soften, leading to printing paper jamming. Therefore, the drying temperature needs to be set to an optimal value by determining the properties of the print medium.

With the drying temperature (color) 505, the temperature of the dryer after printing with color inks can be selected. Similar to the drying temperature (white) 504, an optimal value needs to be set based on a combination of the print medium properties and the printing parameters.

With the tension 506, the tension can be selected that is to be applied to the print medium in the image forming apparatus 100 in which the print medium is conveyed roll-to-roll. If the tension is weak, there will be problems such as loosening of the print medium along the conveyance path, preventing the conveyance at a constant speed, or paper jamming during conveyance. If the tension is set too strong, on the other hand, there is a possibility of the print medium deforming or breaking. It is therefore necessary to select an appropriate value depending on the print medium. The changed printing parameters can be saved by pressing a “Save” button 507.

In searching for an optimal combination of printing parameters while changing a plurality of printing parameters on the parameter editing screen shown in FIG. 5, it can be difficult to determine which printing parameters have been changed and which have not. Therefore, as shown in FIG. 5, the printing parameters before editing are also displayed on the editing screen, allowing the user to always check the printing parameters before editing and easily return to the state before editing starts.

As described above, since the printing parameters are related to each other, changing one printing parameter may change options for another parameter. As an example, a description will be given of differences in the conveyance speed selection pull-down menu between a case of color printing only and a case of color printing and white printing.

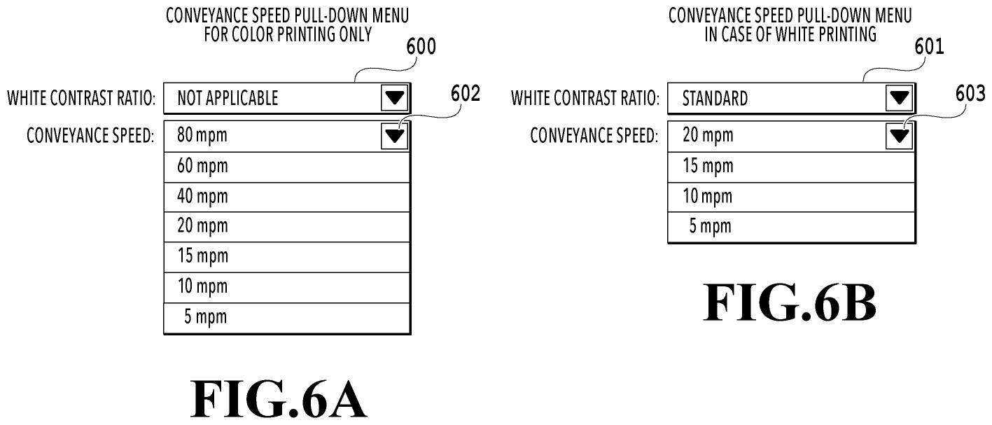

FIGS. 6A and 6B are diagrams showing an example of a pull-down menu. As described above, white printing is used for background printing to block the influence of the background color of the print medium, or for background printing to prevent seeing through a transparent film. Therefore, the white printing is performed so that the ink amount per unit area is larger than in normal color printing, and thus requires the conveyance speed to be set slower than in the case of color printing only. Therefore, in a case of performing the white printing, the conveyance speed options displayed in a conveyance speed selection 603 are different from those in the case of color printing only.

In FIG. 6A, since white printing is not set in a white contrast ratio selection menu 600, only color printing will be performed. A conveyance speed selection 602 shows a state of the conveyance speed pull-down menu in a case of performing color printing only. In the present embodiment, in the case of color printing only, the maximum value of the conveyance speed is 80 mpm. The conveyance speed of 80 mpm is an example, and this value itself has no effect on the present embodiment.

On the other hand, FIG. 6B shows a state in which the white contrast ratio selection menu 601 is set to “Standard” as the white contrast ratio selection. In a case of performing white printing, the maximum value of the conveyance speed selection 603 is limited to 20 mpm. This shows that the maximum value of the conveyance speed is limited compared to the case of color printing only. By changing the maximum value of the conveyance speed during white printing and displaying it in the pull-down menu, the user is prevented from selecting a conveyance speed parameter that cannot be used for white printing. Note that FIG. 6 shows a configuration in which the setting value of the conveyance speed is selected from among a plurality of options displayed in the pull-down menu, but the present embodiment is not limited thereto. Any other configuration may be adopted that allows the setting value of the conveyance speed to be selected from among a plurality of options.

In FIG. 5, in a case where the color ink amount as the printing parameter is changed in the ink amount (color) 501, the color development characteristics of the print result change as the printing color gamut changes and the color density changes during printing. Therefore, it is preferable to readjust the image forming apparatus 100. For example, changing the color ink amount changes the color development characteristics. Therefore, for appropriate printing in desired colors, it is preferable to recreate the color profile used in the color matching processing. However, it is considered to be difficult for the user to understand the relationship between changes in the printing parameters and print results, and to accurately perform various readjustment operations to be performed on the image forming apparatus 100, such as recreating the color profile.

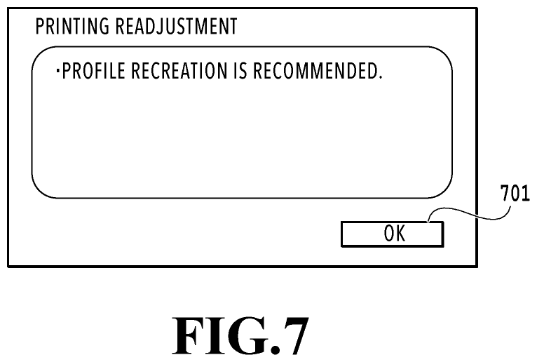

FIG. 7 is an example of a pop-up display screen. Specifically, this is a pop-up screen to notify the user in a case of trying to change the color ink amount as the printing parameter in the ink amount (color) 501 in FIG. 5. By displaying the pop-up screen, the user can recognize that it is desirable to recreate the color profile if he/she changes the color ink amount. If the color profile is not to be recreated even though the ink amount has changed, accurate color reproduction through color matching processing cannot be expected. Furthermore, not only accurate color reproduction cannot be expected but also there is a possibility that the color gamut expanded by changing the ink amount may not be effectively used. On the other hand, in order to recreate a color profile, it is necessary to print a patch image for creating the profile, measure colors, and use the color measurement result to create a color profile through arithmetic processing, which requires a certain amount of man-hours. Recreating the color profile is recommended in a case of changing the color ink amount, but is not mandatory. Therefore, by alerting the user with a pop-up display in a case where he/she wants to change the ink amount, the user can consider whether to change the ink amount by comparing the benefits of changing the ink amount and the hassle of creating a color profile.

The user can dismiss the pop-up display screen by pressing an “OK” button 701 on the pop-up display screen in FIG. 7. The user is notified by the pop-up display in FIG. 7, but a reminder may also be displayed in a predetermined area on the UI screen.

In FIG. 7, the user is notified that it is necessary to recreate the color profile in a case of changing the printing parameter such as the color ink amount in printing with the image forming apparatus 100, but the content of the notification is not limited thereto. For example, a pop-up message may be displayed to alert the user in a case where a specific parameter is changed that causes processing to readjust the image forming apparatus 100, such as calibration or adjustment of print head ink ejection amount.

As another example of the adjustment operations performed by the image forming apparatus 100, correction of a conveyance length of the print medium will be described. In FIG. 5, the conveyance speed of the print medium as the printing parameter can be changed using the conveyance speed selection menu 503. The image forming apparatus 100 described in the present embodiment is a roll-to-roll image forming apparatus 100, which performs a conveyance operation by applying a certain tension to a print medium. This causes the print medium to deform in the conveyance direction, thus requiring conveyance-direction length correction processing. The conveyance length correction processing is related to the conveyance speed. If the conveyance speed of the print medium is changed, the conveyance-direction length correction processing needs to be performed at that conveyance speed.

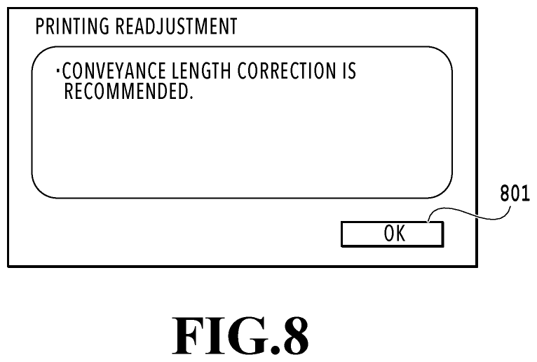

FIG. 8 is a diagram showing an example of a pop-up screen. Specifically, this is a pop-up screen to notify the user in a case where the conveyance speed of the print medium is changed using the conveyance speed selection menu 503 in FIG. 5. By displaying the pop-up screen, the user can recognize that the conveyance length correction processing is required if the conveyance speed is changed. No conveyance length correction processing may affect accurate conveyance of the print medium and drawing during printing depending on the type of print medium. The user can dismiss the pop-up screen, once displayed, by pressing an “OK” button 801.

If the “Save” button 507 in FIG. 5 is pressed after the pop-up display screen such as that shown in FIG. 7 or FIG. 8 is displayed, the display is shifted to a screen for performing the adjustment operations (for example, recreating the profile or correcting the conveyance length) displayed in the pop-up display screen.

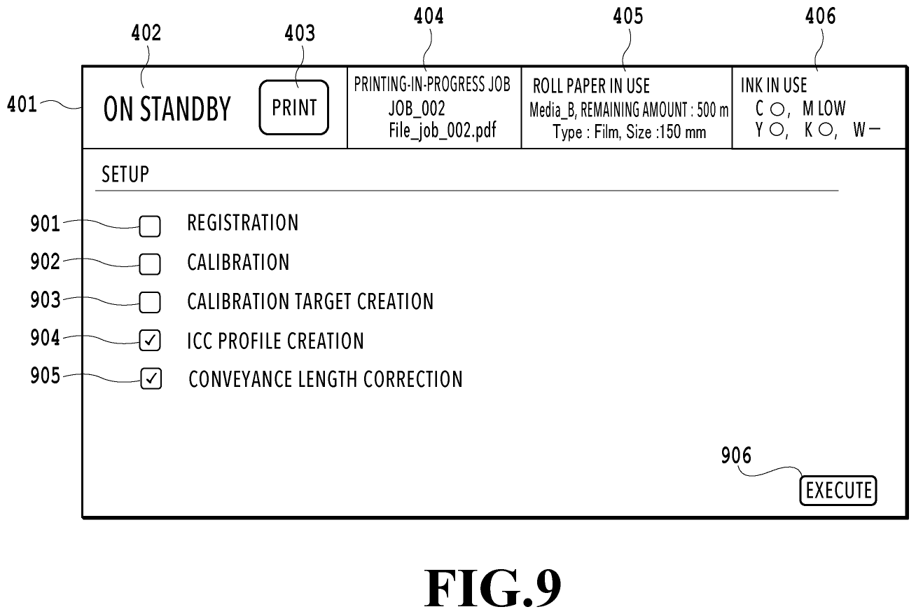

FIG. 9 is a diagram showing an adjustment function selection UI screen. The adjustment function selection UI screen is displayed as the “Save” button 507 is pressed after the printing parameters are edited in FIG. 5. In FIG. 9, the same functions as those in FIG. 4 are denoted by the same reference numerals. A registration function 901 is to adjust the relative positional relationship between print heads of each color so that ink droplets ejected from the print heads mounted on the printing apparatus 102 land in desired and appropriate positions. A calibration adjustment function 902 is to perform calibration to maintain a constant color and density in the result printed on the print medium. A calibration target creation function 903 is to create calibration target data used by the calibration adjustment function 902. The calibration target data is reference data for matching printing conditions. As the calibration is performed, calculations are performed to match this reference data. The calibration target is determined by the combination of ink and a print medium and is thus created for each print medium. As shown in FIG. 5, in a case where the amount of color ink to be applied is changed using the ink amount (color) 501, again, the maximum density or ink density change characteristics of each ink color changes. Therefore, it is preferable to recreate the calibration target and perform calibration adjustment.

A color profile creation function 904 is to create a color profile for a print medium. In the present embodiment, as shown in FIG. 5, in a case where the amount of color ink to be applied is changed using the ink amount (color) 501, the color gamut of printing changes, requiring the color profile to be recreated. If the color profile is not recreated, correct color matching results cannot be obtained and desired colors cannot be reproduced. Therefore, in a case where the amount of color ink to be applied is changed using the ink amount (color) 501, the user is notified by the pop-up display shown in FIG. 7 that it is preferable to recreate the color profile. The checkbox of the color profile creation function 904 in FIG. 9 is pre-checked, for the function recommended for the user to implement, thereby recommending the user to create a color profile. After all the adjustment functions to be performed are selected, an “Execute” button 906 is pressed. The adjustment functions selected by the user are sequentially executed and the results are stored.

Next, a processing flow of displaying the pop-up display screen described above will be described with reference to a flowchart.

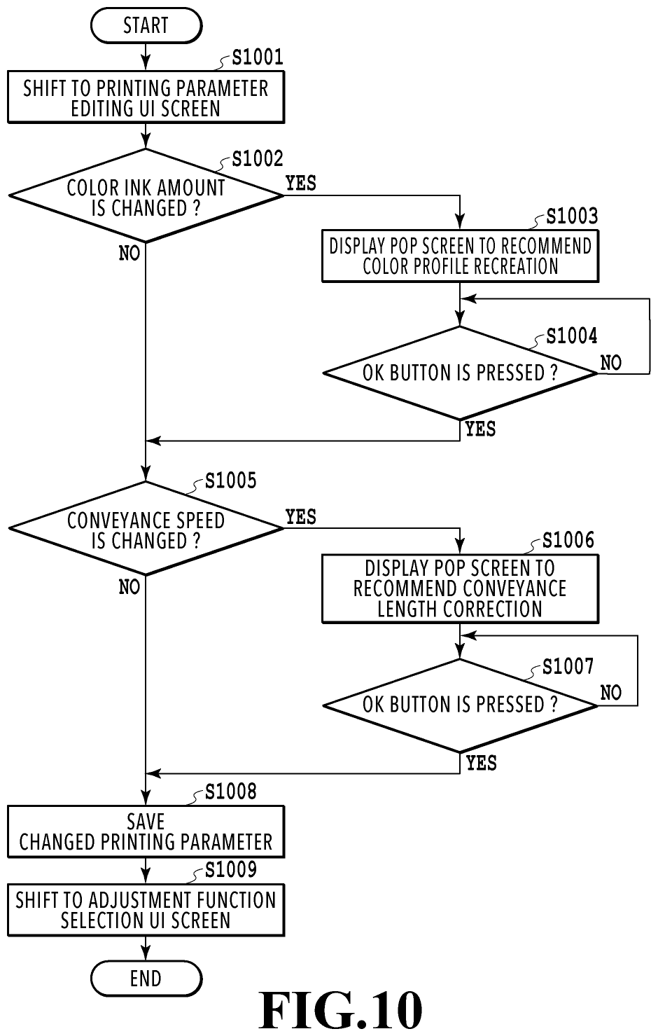

FIG. 10 is a diagram illustrating the processing of displaying a pop-up display screen. This processing starts as the “Edit paper” button 410 is pressed on the entire UI screen 400 shown in FIG. 4. First, in S1001, the control unit 204 of the image forming apparatus 100 shifts to the printing parameter editing UI screen shown in FIG. 5. In the present embodiment, a description will be given of a case where the color ink amount is changed and a case where the conveyance speed is changed through the printing parameter editing UI.

In S1002, the control unit 204 determines whether the color ink amount is changed by the user performing a printing parameter editing operation. If it is determined that the color ink amount is not changed, the control unit 204 proceeds to S1005. On the other hand, if it is determined that the color ink amount is changed, the control unit 204 proceeds to S1003 to display a pop-up display screen to recommend recreation of a color profile as shown in FIG. 7. In S1004, the control unit 204 then determines whether the “OK” button 701 is pressed. If it is determined that the button is pressed, the control unit 204 closes the pop-up display screen and proceeds to S1005. Note that in S1004, it is assumed that the POP screen continues to be displayed until the user presses the OK button, but the present invention is not limited to this, and it may be displayed for a specified fixed period of time.

In S1005, the control unit 204 determines whether the conveyance speed of the print medium has been changed by the user's printing parameter editing operation. If it is determined that the information has not been changed, the control unit 204 advances to S1008. On the other hand, if it is determined that the length has been changed, the control unit 204 advances to S1006 and displays a pop-up display screen that recommends correction of the conveyance length. In S1007, the control unit 204 determines whether the “OK” button 701 is pressed. If it is determined that the button is pressed, the control unit 204 closes the pop-up display screen and proceeds to S1008.

In S1008, the control unit 204 saves the printing parameters edited by the user pressing the “Save” button 507. In S1009, the control unit 204 shifts to the adjustment function selection UI screen shown in FIG. 9. The control unit 204 then ends the processing of this flowchart.

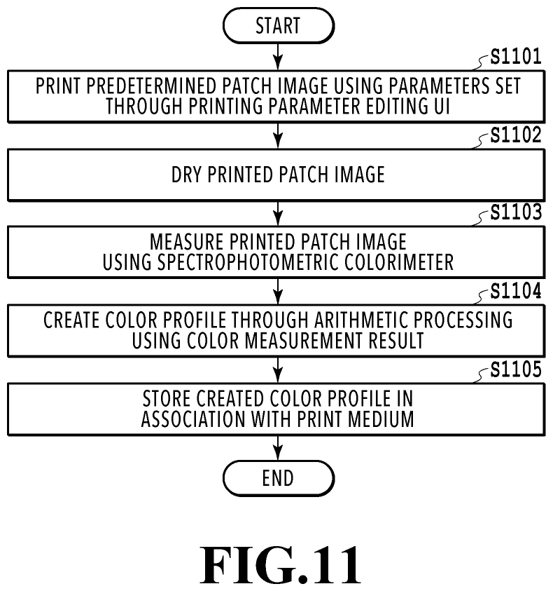

Next, a description will be given of the processing of creating a color profile as one of the function adjustment operations. FIG. 11 is a flowchart showing color profile creation. This processing is sequentially started by pressing the “Execute” button 906 on the adjustment function selection UI screen in FIG. 9.

First, in step S1101, the control unit 204 of the image forming apparatus 100 prints a patch image for creating a color profile using the printing parameters set on the printing parameter editing UI screen shown in FIG. 5. The patch image is a combination of images in which a certain area is filled with a predetermined color. The size of the area is determined by a colorimetric device of a colorimeter that measures colors of the area or the printing accuracy of the image forming apparatus 100. The size is approximately 5 mm×5 mm. A patch image is formed by combining these color patches so as to cover the entire color gamut of the image forming apparatus 100, and the number or arrangement thereof is determined by profile creation software.

In S1102, the control unit 204 dries the printed patch image. The printed patch image needs to be thoroughly dried. Even if color measurement is performed before the patch image is thoroughly dried, accurate colors cannot be measured. It is also necessary to prevent undried ink from adhering to the colorimeter. The image forming apparatus 100 according to the present embodiment is provided with a dryer that performs drying after printing, thus enabling high-speed drying. In an image forming apparatus without a drying function, the printed patch image needs to be thoroughly dried by air-drying.

In S1103, the control unit 204 measures the printed and dried patch image using a spectrophotometric colorimeter. The image forming apparatus 100 of the present embodiment is assumed to be equipped with a colorimeter, the printed color patches can be automatically measured. Once the color measurement is completed, the control unit 204 creates a color profile in S1104 through arithmetic processing using the color measurement result. In S1105, the control unit 204 stores the created color profile in association with the print medium and the printing parameters. The processing of this flowchart is then terminated.

As described above, according to the present embodiment, the convenience in changing parameters can be improved. Specifically, once a printing parameter is changed, a pop-up display screen is displayed to the user, which recommends that the user adjust other settings related to the changed parameter. This makes it possible to notify the user that adjustment operation is necessary.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-089412, filed May 31, 2023, which is hereby incorporated by reference wherein in its entirety.

What is claimed is:

1. A print control apparatus comprising:
an acceptance unit that accepts an editing operation of a parameter set associated with a print medium by a user on an editing screen for editing the parameter set; and
a notification unit that notifies the user in a case where editing a specific parameter among a plurality of parameters included in the parameter set leads to the need for changing other settings related to the specific parameter that are not included in the parameter set.

2. The print control apparatus according to claim 1, wherein
a parameter set before editing is also displayed on the editing screen during the editing operation.

3. The print control apparatus according to claim 1, further comprising:
a transition unit that shifts, in a case where editing a specific parameter among a plurality of parameters included in the parameter set leads to the need for changing other settings related to the specific parameter that are not included in the parameter set, to a screen for changing the other settings after the edited parameter set is saved.

4. The print control apparatus according to claim 1, wherein the notification unit performs notification using a pop-up display screen.

5. The print control apparatus according to claim 1, wherein the notification unit performs notification in a predetermined area of the editing screen.

6. The print control apparatus according to claim 4, wherein the notification unit performs the notification for a certain period of time or until an operation by the user is received.

7. The print control apparatus according to claim 1, wherein the parameters included in the parameter set include the presence or absence of white printing, a contrast ratio in white printing, drying temperature after white printing, drying temperature in color printing, conveyance speed of the print medium, tension applied to the print medium, the type of ink used or the type of color profile used in color matching.

8. The print control apparatus according to claim 2, wherein the acceptance unit accepts, as an editing operation, selection of a setting value from a menu provided for each parameter.

9. The print control apparatus according to claim 8, wherein contents of the menu are changed in response to changes in other parameters included in the parameter set.

10. A method for controlling a print control apparatus, comprising the steps of:
accepting an editing operation of a parameter set associated with a print medium by a user on an editing screen for editing the parameter set; and
notifying the user in a case where editing a specific parameter among a plurality of parameters included in the parameter set leads to the need for changing other settings related to the specific parameter that are not included in the parameter set.

11. A non-transitory computer readable storage medium storing a program which functions in a print control apparatus and causes the print control apparatus to function as:
an acceptance unit that accepts an editing operation of a parameter set associated with a print medium by a user on an editing screen for editing the parameter set; and
a notification unit that notifies the user in a case where editing a specific parameter among a plurality of parameters included in the parameter set leads to the need for changing other settings related to the specific parameter that are not included in the parameter set.
